(19) United States
(12) Patent Application Publication
(10) Pub. No.: US 2009/0009905 A1
(43) Pub. Date: Jan. 8, 2009

(54) IMAGE RECORDING APPARATUS

(75) Inventor: Etsuyasu KONDO, Tama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/165,762

(22) Filed: Jul. 1, 2008

(30) Foreign Application Priority Data
Jul. 3, 2007 (JP) 2007-175532

(51) Int. Cl. G11B 5/584

(52) U.S. Cl. 360/77.13

(57) ABSTRACT

An image recording apparatus includes two drums, where such a configuration is adopted that both an approaching or spacing direction of a first recording head section corresponding to a first drum of the drums and an approaching or spacing direction of a second recording head section provided corresponding to a second drum of the drums coincide with a width direction (an X-direction) of a recording apparatus main body and are parallel to each other, and a space required by the first recording head section at a spacing completion time and a space required by the second recording head section at a spacing completion time overlap with each other as viewed from a Y-direction.

### CROSS-REFERENCE TO RELATED APPLICATIONS

This application is based upon and claims the benefit of priority from prior Japanese Patent Application No. 2007-175532, filed Jul. 3, 2007, the entire contents of which are incorporated herein by reference.

### BACKGROUND OF THE INVENTION

1. Field of the Invention

The present invention relates to an image recording apparatus which has a plurality of drums, each having an image recording section, and conducts image recording on both surfaces of an elongated recording medium.

2. Description of the Related Art

In general, as an apparatus which ejects inks of plural colors to a cut-sheet recording medium being conveyed individually and records images, inkjet printers have been known. There is a recording apparatus of the inkjet printers which has a line recording head where a plurality of nozzles ejecting ink droplets is arranged and fixed in a direction orthogonal to a conveying direction of a recording medium.

Since the line recording head can be expected to have high throughput and can also record an image on continuous paper (hereinafter, called “a continuous recording medium”) such as a rolled paper, it can be used for industrial application. For example, Jpn. Pat. Appln. KOKAI Publication No. 2003-63707 proposes an image recording apparatus which can conduct two-sided recoding.

As shown in FIG. 8, the image recording apparatus has two first and second drums 100 and 101 each having a conveying mechanism which conveys a continuous recording medium in a winding manner and a platen mechanism, inkjet line recording heads 102 and 103 extending in axial directions of the respective drums 100 and 101 being disposed corresponding to the respective drums 100 and 101. Both the line recording heads 102 and 103 includes recording sections having four lines arranged at equal intervals in circumferential directions of the drums 100 and 101. The recording sections eject inks onto both surfaces of a continuous recording medium in time with pulse signals generated by a position detecting section to conduct two-sided recording.

The inkjet recording head generally has a maintenance unit for conducting maintenance of the nozzles or nozzle surfaces. For example, Jpn. Pat. Appln. KOKAI Publication No. 11-277764 (Patent Document 2) discloses a recording apparatus where a drum 105 configuring a portion of a conveying mechanism for cut sheet paper, roll paper or the like has a maintenance unit 106. In a technique disclosed in Patent Document 2, as shown in FIG. 9, the drum 105 is rotated while holding a recording medium thereon in a winding turning manner so that image recording is performed by a recording head 107 disposed so as to face the drum 105.

The recording head 107 can be ascended (separated) from an outer peripheral surface of the drum 105 by an elevating mechanism 109 attached to a head holding member 108. The head holding member 108 is ascended or descended to each height of a recording position, a maintenance position or a non-recording position which is preliminarily determined. When the recording head is in the non-recording position, the maintenance unit 106 is rotated from a standby position to a position where it faces the maintenance unit 106 by a rotating mechanism and the head holding member 108 is descended so that a maintenance member is caused to abut a nozzle surface.

The maintenance units disclosed in Jpn. Pat. Appln. KOKAI Publication No. 11-277764 can be provided corresponding to two drums disclosed in Jpn. Pat. Appln. KOKAI Publication No. 2003-63707. However, when this is done, the area occupied by the recording apparatus becomes large. Specifically, as shown in FIG. 8, distances (head thicknesses) between drum outer peripheral surfaces of the respective drums 100 and 101 and outsides (non-jet surface) of the line recording heads 102 and 103 are represented as sizes A.

Further, distances from closed positions to spaced positions where the line recoding heads 102 and 103 have been spaced from the drum outer peripheral surfaces of the drums 100 and 101 for conducting maintenance action are represented as B. Therefore, besides an arrangement space for the two drums, a size corresponding to a size of (2A+2B) is required for a width of the apparatus, which results in increase of the width of the apparatus. Incidentally, the width of the apparatus is increased according to increase of a distance Lw between shafts of two drums 100 and 101 in a width direction.

### BRIEF SUMMARY OF THE INVENTION

An object of the present invention is to provide an image recording apparatus which records images on both surfaces of a continuous recording medium with a simple arrangement configuration while space saving of an installation occupation area is achieved by size reduction of the recording apparatus.

Embodiments according to the present invention provide an image recording apparatus comprising: a first drum which is rotatably supported while holding a recording medium in a winding state of the recording medium on an outer peripheral surface of the first drum such that the outer peripheral surface comes in close contact with a back side of the recording medium; a second drum which is rotatably supported while holding the recording medium in a winding state of the recording medium on an outer peripheral surface of the second drum such that the outer peripheral surface comes in close contact with an front side of the recording medium; a first recording head which is disposed so as to face the outer peripheral surface of the first drum such that the first recording drum can be spaced from the outer peripheral surface and conducts recording on the front side of the recording medium wound on the outer peripheral surface of the first drum; and a second recording head which is disposed so as to face the outer peripheral surface of the second drum such that the second recording drum can be spaced from the outer peripheral surface and conducts recording on the back side of the recording medium wound on the outer peripheral surface of the second drum, the first recording head being movable in a first direction where the first recording head is spaced from the first drum between a recording position where the first recording head conducts recording on the recording medium on the first drum and a maintenance position where maintenance of the first recording head is performed, the second recording head being movable in a direction parallel to the first direction between a recording position where the second recording head conducts recording on the recording medium on the second drum and a maintenance position where maintenance of the second recording head is performed, and a movable region of the first recording head and a movable region of the second recording head being determined such that the movable regions of the first and second recording heads overlap with each other at least partially when the movable regions are projected on a plane containing a second axis parallel to the first direction and are viewed from a first axis perpendicular to the first direction.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of an image recording apparatus according to a first embodiment of the present invention;

FIG. 2 is a diagram showing a recording position of a first recording head section at an image recording time in the first embodiment;

FIG. 3 is a diagram showing a non-recording position of the first recording head section at an image non-recording time in the first embodiment;

FIG. 4 is a diagram showing a state where a first maintenance unit has been rotated for maintenance in the first embodiment;

FIG. 5 is a diagram showing positions of the first recording head section and the first maintenance unit at a maintenance time in the first embodiment;

FIG. 6 is a diagram showing a configuration of an image recording apparatus according to a second embodiment of the present invention;

FIG. 7 is a diagram showing a configuration of an image recording apparatus according to a third embodiment of the present invention;

FIG. 8 is a diagram showing a configuration of a first example of a conventional image recording apparatus; and

FIG. 9 is a diagram showing a configuration of a second example of the conventional image recording apparatus.

### DETAILED DESCRIPTION OF THE INVENTION

Embodiments of the present invention will be explained below in detail with reference to the drawings.

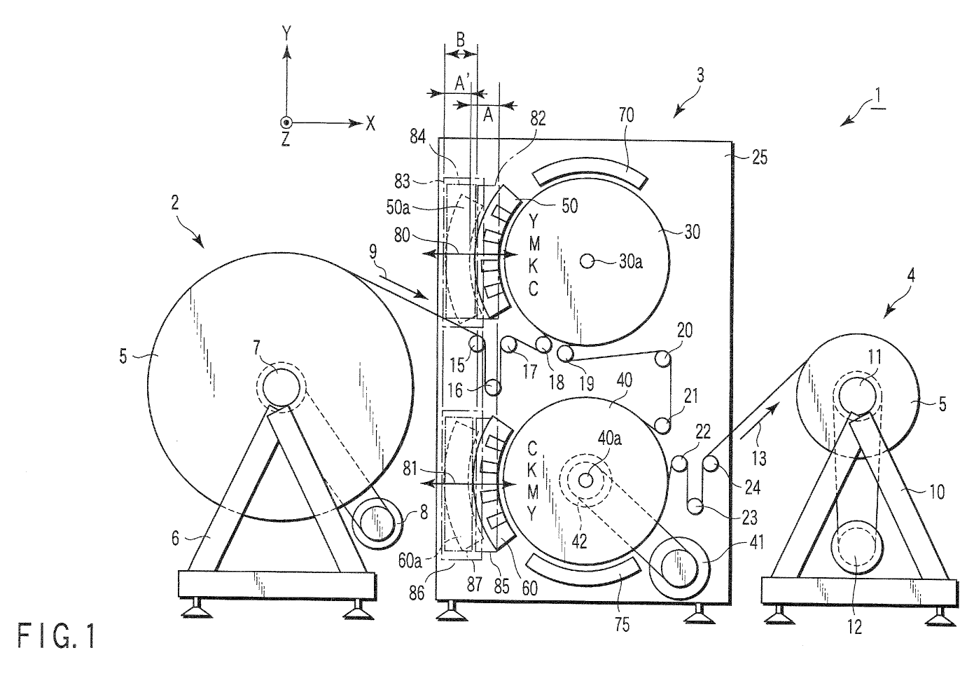

FIG. 1 is a diagram showing a configuration of an image recording apparatus according to a first embodiment of the present invention.

An image recording apparatus 1 according to the embodiment comprises a supply section (or an unwinding section) 2, a recording apparatus main body 3, and a delivery section (a takeup section or a winding section) 4. Incidentally, FIG. 1 shows a configuration of the recording apparatus main body 3 viewed from a front thereof, where an X-direction shows a width direction of the apparatus, a Y-direction shows a height direction, and a Z-direction shows a depth direction.

In each of the embodiments described below, the term “moving space” is used to refer to various spaces. Specifically, the moving space includes the following spaces. (1) a space required for the recording head section to approach the drum (a moving locus which the recording head section describes from an approach completion position to a spacing completion position), (2) a space required by the recording head section at an approaching completion time to the drum (a space occupied by the recording head section when the recording head section has completed the approach), (3) a space required for the recording head section to be spaced from the drum (a moving locus of the recording head section during spacing thereof to the drum), and (4) a space required by the recording head section at a spacing completion time (a space occupied by the recording head section when the spacing of the recording head section has been completed). In the embodiment, the term “approaching” or “spacing” means moving.

First, the supply section 2 which feeds a continuous recording medium will be explained.

The supply section 2 comprises a reel section 5 including a continuous recording medium such as a rolled paper wound around thereon, a shaft 7 supporting the reel section 5 rotatably, a stand 6 supporting the shaft 7, and a brake 8 controlling rotation of the reel section 5. A rolled paper which is the continuous recording medium used in the embodiment is a rolled paper having, for example, a paper width of 318 mm (12.5 inches), a winding diameter of 0.7 m, and a weight of about 110 kg.

The shaft 7 fixes a takeup shaft (a paper tube or core) of the rolled paper in the reel section 5. Though not illustrated, a tube comprising an elastic member and sealed, an air charging port attached to the tube, and a plurality of protrusion portions arranged on an outer periphery of the tube and capable of protecting are provided within the shaft 7. The protrusion portions can project in a radial direction of the continuous recording medium from long holes arranged in a staggered manner in a width direction of the continuous recording medium.

When the reel section 5 including a wound around rolled paper is fitted on the shaft 7, air is charged from the air charging port into the tube. The tube is inflated by air so that the plurality of protrusion portions is pushed out to be caused to bite an inner diameter side of a take-up shaft. The reel section 5 is fixed to the shaft 7 by the protrusion portions. Reaction force of the brake 8 is transmitted to the shaft 7 via a pulley and a belt so that back tension is caused to act on the continuous recording medium fed out in a direction of arrow 9. A power clutch is disposed between the pulley and the brake 8 and it functions so as to adjust back tension in a opposite direction to a conveying direction of the continuous recording medium. The brake 8 can be properly adjusted regarding its reaction force.

Subsequently, the recording apparatus main body 3 will be explained.

The recording apparatus main body 3 records images on both surfaces of a fed continuous recording medium to discharge the recording medium. The recording apparatus main body 3 comprises a plurality of rollers 15 to 24 configuring a conveying mechanism, a first drum 30, a second drum 40, a first recording head section 50, a second recording head section 60, a first maintenance unit 70, and a second maintenance unit 75, and it is accommodated in a main body frame 25.

In the conveying mechanism, a continuous recording medium fed out from the supply section 2 is conveyed to the first drum 30 via a free roller 15, a first tension sensor roller 16, and a free roller 17. The first tension sensor roller 16 includes differential-type tension detection sensors (not shown) on both ends of a front side and a back side thereof. Fluctuation of back tension is caused by eccentricity of a continuous recording medium held by the reel section 5 in the supply section 2 or the like. When slack of the continuous recording medium occurs, the tension detection sensors detect the degree of the slack. The brake 8 is activated based upon a detection signal from the tension detection sensors, so that the back tension is controlled so as to cancel the slack of the continuous recording medium.

Next, the continuous recording medium having an image recorded on its one surface, for example, its back side, by the first drum 30 is conveyed to the second drum 40 via free rollers 19, 20, and 21. Further, the continuous recording medium having another image recorded on the other surface (the front side) by the second drum 40 is fed out to the delivery section 4 via a free roller 22, a second tension sensor roller 23, and a free roller 24. The second tension sensor roller 23 includes differential-type tension detection sensors (not shown) on both ends of a front side and a back side thereof.

Next, a configuration of the first drum 30 will be explained.

The first drum 30 is formed by metal, such as, aluminum in a hollow cylindrical shape. A rotational shaft 30a of the first drum 30 is engaged with one end of a member which supports the first recording head section 50 described later, and it is also engaged with one end of a member which supports the first maintenance unit 70 described later. In the first drum 30, the rotational shaft 30a is rotatably supported by the main body frame 25.

In the embodiment, the first drum 30 is configured, for example, such that a continuous recording medium can be wound on the first drum 30 in a range of a winding angle of 330°, corresponding to a length of three times that of the A3 sheet (420 mm). Normal force to an outer peripheral surface of the first drum 30 is imparted to the continuous recording medium by the back tension at a winding start time to the first drum 30 and the tension at a winding end time to the first drum 30. The continuous recording medium is held on the first drum 30 by the normal force and friction coefficient acting between the first drum 30 and the continuous recording medium. Thereby, the first drum 30 serves as an idle drum pulled and rotated by the continuous recording medium according to rotation of the second drum 40. Incidentally, as a method for holding a continuous recording medium, a holding method other than the method utilizing friction may be adopted. For example, many small holes are opened on a surface of a drum, and an internal space of the drum is suctioned by a suction pump to generate negative pressure state. It is possible to hold a continuous recording medium by the negative pressure.

Next, a configuration of the second drum 40 will be explained.

The second drum 40 has a configuration similar to that of the first drum 30. The second drum 40 is formed by aluminum in a hollow cylindrical shape, and a rotational shaft 40a thereof is engaged with one end of a member which supports the second recording head section 60 described later, while it is also engaged with one end of a member which supports the second maintenance unit 75 described later. The rotational shaft 40a is rotatably supported by the main body frame 25. The second drum 40 in the embodiment is configured such that a continuous recording medium can be wound on the second drum at a winding angle of 330° and it is set to have a circumferential length corresponding to a length of three times that of the A3 sheet (420 mm).

The continuous recording medium is held on the second drum 40 and conveyed by normal resistance force imparted on an outer peripheral surface of the second drum 40 and friction coefficient between the second drum 40 and the continuous recording medium in the same manner as the first drum 30. A drive motor 41 is attached to the rotational shaft 40a via a pulley and a belt. The second drum 40 functions as a driving drum owing to the driving force thereof.

An encoder 42 is coupled to the rotational shaft 40a via a coupling. A housing of the encoder 42 is fixed to one end of an encoder fixing member with an L-shaped section, and the other end of the encoder fixing member is fixed to a back side of the main body frame 25. With such a configuration, the rotational shaft of the encoder 42 is rotated according to rotation of the second drum 40 so that the encoder 42 outputs a detection pulse corresponding to a rotation position of the second drum 40.

The detection pulse is input into a driving substrate (not shown) for driving respective nozzles of the first recording head section 50 and the second recording head section 60, so that inks are ejected from the respective nozzles in synchronism with detection pulses. As the encoder 42, for example, a commercially-available rotary encoder outputting 18000 pulses per one rotation is used. For example, when a resolution in a conveying direction of a continuous recording medium is 300 dpi, setting is conducted such that one pulse output from the encoder 42 corresponds to one dot (printing one). Thereby, when a commercially-available rotary encoder outputting 18000 pulses per one rotation is used, a diameter of the second drum 40 becomes 25.2 inches÷300 dpi×18000 pulses÷circle ratio π=485 mm. Here, a diameter of the first drum 30 is equal to that of the second drum 40. With such a configuration, recording heads of the first recording head section 50 and the second recording head section 60 can eject ink in synchronism with detection pulses from the encoder 42 to be able to conduct recording of a resolution of 300 dpi in the conveying direction.

The continuous recording medium which is wound on the second drum 40 and is recorded with an image is picked up by the free roller 22 to be fed out to the delivery section 4 via the second tension sensor roller 23 and the free roller 24.

The second tension sensor roller 23 functions in a similar manner to the abovementioned first tension sensor roller 16. Slack of the continuous recording medium is detected by a tension detection sensor. A power clutch coupled to a fixing shaft 11 of the delivery section 4 is activated to control tension of the continuous recording medium based upon a detection signal output from the tension detection sensor.

Subsequently, the delivery section 4 accommodating the continuous recording medium with recorded images will be explained.

The delivery section 4 is a takeup mechanism which takes up a continuous recording medium discharged from the recording apparatus main body 3 in a direction of arrow 13. The delivery section 4 comprises a reel section 5 taking up a continuous recording medium having recorded images, the shaft 11 rotatably supporting the reel section 5, a stand 10 supporting the shaft 11, and a takeup drive motor 12 which rotates the reel section 5 to take up a continuous recording medium. Further, the delivery section 4 includes the stand 10 and the fixing shaft 11.

The stand 10 rotatably supports the shaft 11 and holds the continuous recording medium which has been taken up on the reel section 5. The driving force of the takeup drive motor 12 is transmitted to the shaft 11 via a pulley and a belt so that the reel section 5 is rotated and the continuous recording medium is taken up on the reel section 5. The shaft 11 also has the same configuration as the shaft 7, where a tube inside the shaft 11 is inflated by charging air into the tube from an air charging port (not shown) to protrude a plurality of protrusion portions so that the reel section 5 is fixed to (held state) the shaft 11. A power clutch is disposed between the pulley and the takeup drive motor 12 so that tension of the continuous recording medium in a conveying direction thereof is adjusted by the power clutch.

Next, the first recording head section 50 and the second recording head section 60 will be explained with reference to FIGS. 1 to 5.

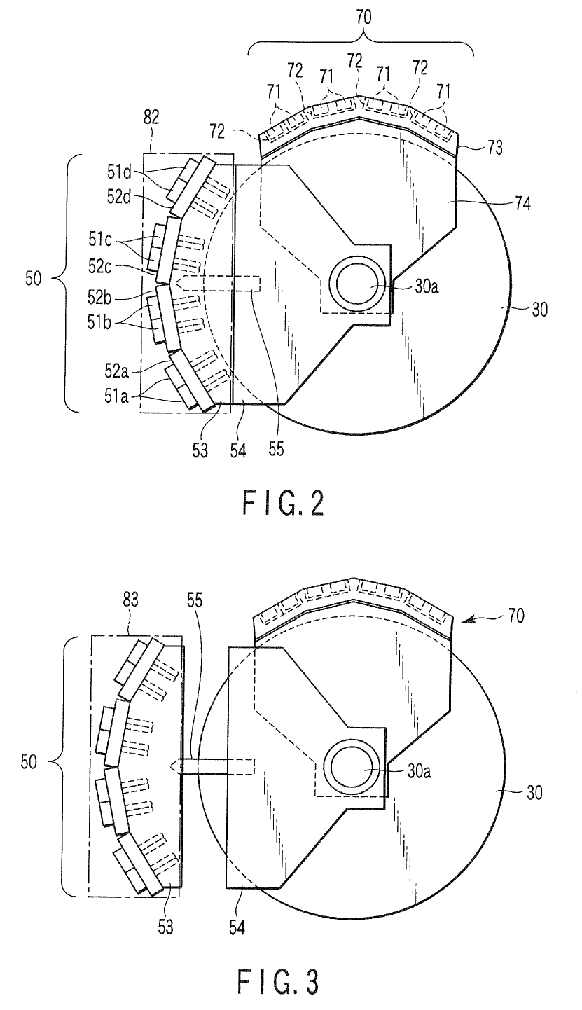

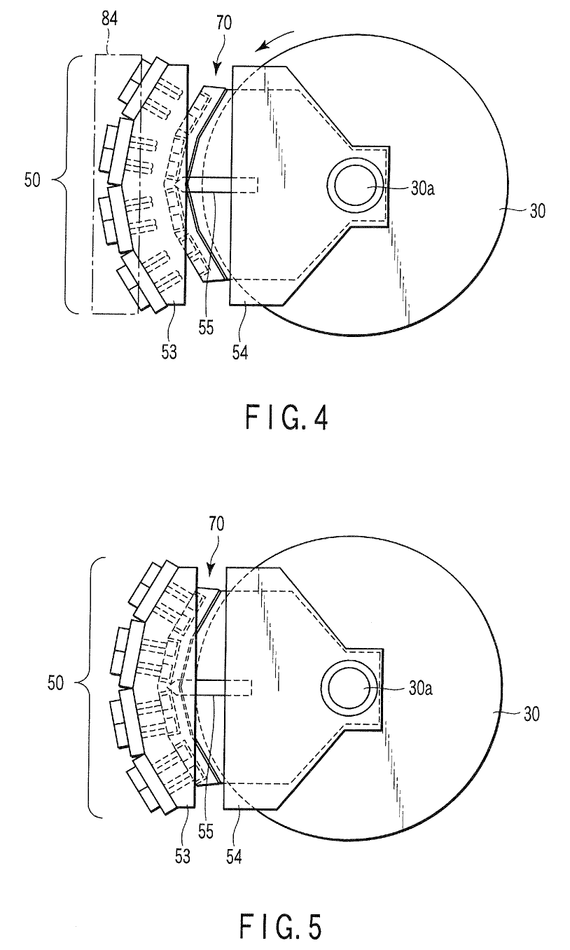

Each of the first recording head section 50 and the second recording head section 60 is an ink ejecting apparatus which ejects ink onto a continuous recording medium conveyed by each drum to record an image on the continuous recording medium. FIG. 2 shows a recording position of the first recording head section 50 at an image recording time, FIG. 3 shows a non-recording position of the first recording head section 50 at an image non-recording time, and FIG. 4 is a diagram showing a state where the first maintenance unit 70 has been rotated and positioned between the first recording head section 50 and the first drum 30, for maintenance. FIG. 5 is a diagram showing positions of the first recording head section 50 and the first maintenance unit 70 at a maintenance time. Incidentally, jamming, part replacement, or the like is performed by moving the first recording head section 50 up to a position corresponding to an image non-recording time.

The first recording head section 50 in the embodiment includes recording heads 51a, 51b, 51c and 51d (hereinafter, shown as 51a to 51d) corresponding to total four colors of cyan (C), black (K), magenta (M), yellow (Y). Of course, the number of ink colors is not limited if an arrangement space can be ensured, and the number may be one, or five or more.

The recording heads 51a to 51d shown in FIG. 2 are fixed on head holding plates 52a, 52b, 52c and 52d (hereinafter, shown as 52a to 52d), respectively. The recording heads 51a to 51d are of a line head type having a length equal to or more than at least a width of a continuous recording medium or of a short head arrangement type where a plurality of recording heads having a length less than or equal to a width of a continuous recording medium is arranged in staggered manner. Of course, arrangement of the recording heads is not limited to these two arrangement patterns.

Nozzle surfaces at distal ends of the recording heads 51a to 51d are arranged so as to correctly face a recording surface of a continuous recording medium held on an outer peripheral surface of the first drum 30. Such an arrangement can be realized by holding the recording heads 51a to 51d such that the recording heads 51a to 51d are adjusted by the head holding plates 52a to 52d and the head holding member 53.

Though not illustrated, ink supply sections supplying inks of different colors to the recording heads 51a to 51d, respectively, and a head control board for controlling ink ejection by the recording heads 51a to 51d may be mounted on the first recording head section 50 in the embodiment.

Relative positions of the recording heads 51a to 51d to the first drum 30 are determined through a supporting member 54 whose one end is engaged with the rotational shaft 30a of the first drum 30, a guide shaft 55 on the other end of the supporting member 54 and extending in a radial direction of the first drum 30, the head holding member 53, and the head holding plates 52a to 52d. Incidentally, the supporting member 54 and the guide shaft 55 configure a recording head section moving mechanism.

The recording head section 50 is horizontally spaced or approached to the first drum 30 by the guide shaft 55 protruded and retreated by the recording head section moving mechanism (not shown). The recording head section moving mechanism comprises, a well-known configuration, for example, a combination of a moving mechanism such as a cam, a link, a rack, a pinion, and the like and a driving source. Besides, the guide shaft 55 may be moved using a hydraulic cylinder or the like as the moving mechanism. Incidentally, the second recording head section 60 has the same configuration as that of the abovementioned first recording head section 50 except for an arrangement where an arrangement order of the recording heads 61 from an upstream side in the conveying direction is reversed to the arrangement order of the first recording heads 51 (color order of inks in the former becomes equal to that in the latter), and specific explanation thereof is omitted.

Next, the first maintenance unit 70 and the second maintenance unit 75 will be explained.

The first maintenance unit 70 and the second maintenance unit 75 each have a function of conducting maintenance action such as wiping or nozzle suction in order to prevent clogging in the nozzles of the recording heads and deposition of dusts (for example, paper dust).

The first maintenance unit 70 has a plurality of suction nozzles 71 corresponding to the recording heads 51a to 51d of the first recording head section 50, four first ink pans 72 recovering inks purged from the respective recording heads 51a to 51d, a second ink pan 73 formed from sheet metal integrally with the pans so as to cover the four first ink pans 72, and a maintenance unit holding member 74 positioning the abovementioned constituent elements relative to the first drum 30 and holding them.

A maintenance operation of the maintenance mechanism with such a configuration will be explained.

First, execution of the maintenance is instructed after a predetermined time elapses, after a predetermined number of recorded sheets is reached, or by a user as appropriate. According to the instruction, the first recording head section 50 is moved from the recording position shown in FIG. 2 to the non-recording position (a position at a spacing completion time) shown in FIG. 3 according to protrusion of the guide shaft 55 conducted by the recording head section moving mechanism. A position at the spacing completion time is the most spaced position where, even if the first maintenance unit 70 described later is rotated to move to a position between the first recording head section 50 and the first drum 30, the first recording head section 50 does not contact with the first maintenance unit 70.

Next, when the first recording head section 50 reaches a position at the spacing completion time, the first maintenance unit 70 is rotated in a direction of arrow shown in FIG. 4 to move to a position between the first recording head section 50 and the first drum 30, namely, to the maintenance position. After the first maintenance unit 70 is moved, as shown in FIG. 5, the first recording head section 50 which is located at a position at the spacing completion time is moved to approach the first drum 30. The movement of the first recording head section 50 is stopped at a position (the maintenance position) where the nozzle surfaces of the recoding heads 51a to 51d abut the plurality of suction nozzles 71 of the first maintenance unit 70.

A purging action of ink from the recording heads 51a to 51d of the first recording head 50 is performed in the state shown in FIG. 5. Ink which has flowed during the purging action is recovered in the four first ink pans 72 corresponding to the recording heads 51a to 51d to be collected in a waste liquid tank.

Thereafter, the suction nozzles 71 put in the abutting state on the nozzle surfaces of the recording heads 51a to 51d are scanned in a nozzle row direction, so that ink remaining on the nozzle surfaces is suctioned by the suction nozzles 71 while ink and/or paper dust or the like attached to the nozzle surfaces is being wiped off. After termination of the maintenance, an operation reversed to the abovementioned operation, namely, a series of operations are completed by moving the recording head 50 to a position at the spacing completion time, rotating the maintenance unit 70 in the clockwise direction as viewed in the Figures, and moving the recording head 50 toward the first drum 30 and returning it to the recording position, as shown in FIGS. 5, 4, 3, and 2. Incidentally, the second maintenance unit 75 performs similar operations to those of the first maintenance unit 70 except for a point that an arrangement order of the suction nozzles for respective colors is reversed to the configuration of the abovementioned the first maintenance unit 70 and a point that a rotation direction for conducting rotation to the maintenance position is reversed to that in the first maintenance unit 70.

Next, an arrangement of the first recording head section 50 and the second recording head section 60 configuring a feature of the first embodiment will be explained. As explained above, FIG. 1 shows a configuration of the recording apparatus main body 3 viewed from the front, where X-direction indicates a width direction of the apparatus, Y-direction indicates a height direction thereof, and Z-direction indicates a depth direction thereof.

As shown in FIG. 1, the first recording head section 50 and the second recording head section 60 according to the first embodiment are arranged on the left sides of the first drum 30 and the second drum 40, respectively, as viewed from the front of the recording apparatus main body 3. Both an approaching or spacing direction 80 of the first recording head section 50 to the first drum 30 (a descending or ascending direction to the drum surface) and an approaching or spacing direction 81 of the second recording head section 60 to the second drum 40 coincide with the width direction of the recording apparatus main body 3 (X-direction, or a horizontal direction) and they are parallel to each other.

With such an arrangement of the first recording head section 50 and the second recording head section 60, approaching or spacing behaviors of the recording head sections 50 and 60 to the respective drums 30 and 40 can be performed independently from each other or simultaneously when the maintenance operation is performed.

When the positions where the first and second recording head sections 50 and 60 are located at the time of recording and the positions where they are located when the spacing is completed are viewed in the Y-direction and are projected in the width direction of the recording apparatus main body 3, i.e., on the plane containing the approaching direction or spacing direction of the recording head sections 50 and 60 (that is, the horizontal plane parallel to the floor surface), the recording head sections 50 and 60 are observed as overlapping with each other at the same position.

Likewise, when the positions where the first and second recording head sections 50 and 60 are located at the time of recording and the positions where they are located when the spacing is completed are viewed in the Y-direction and are projected on the axis containing the approaching direction or spacing direction of the recording head sections 50 and 60, the recording head sections 50 and 60 are observed as overlapping with each other at the same position.

The “overlap” as used in the present embodiment is intended to mean that (1) the space required by the recording head section 50 and the space required by the recording head section 60 overlap with each other at various positions (recording positions, maintenance positions, closest positions, most spaced positions) in the width direction of the recording apparatus main body 3 (i.e., the approaching position or spacing position), or that (2) the space overlapping in the approaching or spacing direction is shared as operation ranges of the recording head sections 50 and 60, and the recording head sections 50 and 60 use that space alternately.

Let us consider how the first and second recording head sections 50 and 60 actually move in the approaching or spacing direction 80, 81. The space (movement region) 84 which the first recording head section 50 requires for the approaching or spacing movement and the space (movement region) 87 which the second recording head section requires for the approaching or spacing movement overlap with each other, when they are viewed in Y-direction and are projected on the axis containing the approaching or spacing direction of the recording head sections 50 and 60.

Likewise, the space (movement region) 84 which the first recording head section 50 requires for the approaching or spacing movement and the space (movement region) 87 which the second recording head section requires for the approaching or spacing movement overlap with each other, when they are viewed in Y-direction and are projected on the plane containing the approaching or spacing direction of the recording head sections 50 and 60 (i.e., the horizontal plane parallel to the floor surface).

Here, assuming that a size of the spaces 82 and 85 required by the recording head sections located at the recording positions and the spaces 83 and 86 required by the respective recording head sections at the spacing completion time in the approaching or spacing is directions 80 and 81 of the respective recording head sections is represented as A and a size of the spaces 84 and 87 required by the recording head sections for the approaching or spacing in the approaching or spacing directions 80 and 81 of the recording head sections is represented as B, a size of the recording apparatus main body in the width direction (the X-direction or a direction parallel to the approaching or spacing direction) is substantially determined by a size obtained by adding the size A+the size B to a diameter of one drum (the platen gap is ignored).

As described above, according to the embodiment, the spaces 82 and 85 which the recording head sections require at the time of recording are projected on the axis parallel to the approaching or spacing direction of the recording head sections or on the plane containing the moving directions of the recording head sections, and the projected images are viewed in the height direction of the apparatus main body (i.e., in Y-direction). The width of the recording apparatus main body can be reduced by arranging the respective recording head sections relative to the respective drums so as to cause the projected images of the recording head sections to overlap with each other as viewed from the height direction. Incidentally, even when the spaces 82 and 85 required by the respective recording head sections at the recording time are not caused to completely overlap with each other as a whole, if the respective recording head sections are arranged so as to obtain partial overlapping, such an effect can be achieved that the width of the recording apparatus main body 3 as viewed from the circumferential surface is reduced.

Likewise, the spaces 82 and 85 which the recording head sections require at the end of the spacing movement are projected on the axis parallel to the approaching or spacing direction of the recording head sections or on the plane containing the moving directions of the recording head sections, and the projected images are viewed in the height direction of the apparatus main body (i.e., in Y-direction). The width of the recording apparatus main body 3 can be reduced by arranging the respective recording head sections at positions away from the drums so as to cause the projected images of the recording head sections to overlap with each other as viewed from the height direction. Incidentally, the spaces 82 and 85 required by the respective recording head sections at the end of the spacing movement do not have to overlap with each other completely. That is, if the respective recording head sections are arranged so as to obtain partial overlapping, the width of the recording apparatus main body 3 is reduced.

Further, the spaces (moving region, moving locus) 84 and 87 which the first recording head section 50 and the second recording head section 60 require when they move between the recording position and the spacing completion position are projected on the axis parallel to the approaching or spacing direction of the recording head sections or on the plane containing moving directions of the recording head sections, and the projected images are viewed in the height direction of the apparatus main body (in Y-direction). The moving region of each recording head section is determined in such a manner that the projected images of the moving regions of the recording head sections overlap with each other. The width of the recording apparatus main body can be reduced by determining the moving region as above. Incidentally, the spaces 84 and 87 which the recording head sections require when they move between the recording position and the spacing completion position do not have to overlap with each other completely. That is, if the respective recording head sections are arranged so as to obtain partial overlapping, the width of the recording apparatus main body 3 is reduced.

In the embodiment, overlap between the spaces required by the respective recording head sections at the recording time, overlap between the spaces required by them at the spacing completion time, and overlap between the spaces required for the respective recording head sections to move between a position at the recording time and a position at the spacing completion time are achieved when they are projected on the axis parallel to the moving directions of the recording head sections or on the plane containing the moving directions of the recording head sections. Needless to say, however, where one of the overlaps mentioned above is attained, the width of the recording head main body 3 can be reduced.

With the abovementioned configuration, the width of the recording apparatus main body can be reduced, installation of the recording apparatus main body can be conducted in a small area, and an apparatus which can realize space saving can be provided. By reducing the width of the recording apparatus main body, an apparatus which can realize size reduction and weight reduction can be provided. The first recording head section 50 and the second recording head section 60 in the embodiment are arranged on the left sides of the respective drums 30 and 40 as viewed from the front, but even when they are arranged on the right sides thereof, a similar effect can be achieved.

Next, a second embodiment will be explained.

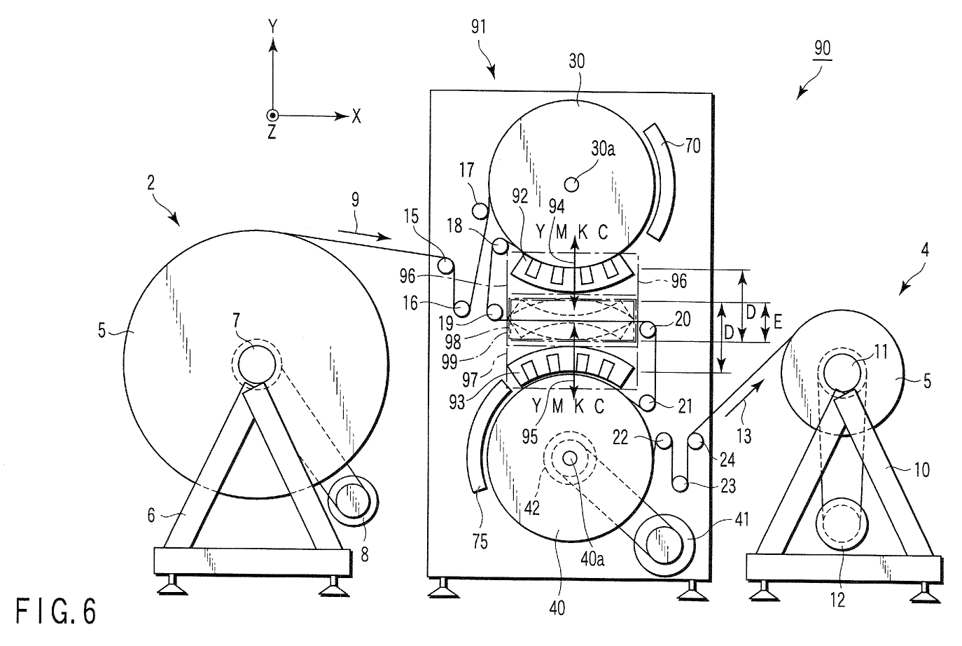

FIG. 6 is a diagram showing a configuration of an image recording apparatus according to a second embodiment of the present invention.

Configuration sections of the image recording apparatus according to the embodiment equivalent those according to the first embodiment are attached with same reference numbers and explanation thereof is omitted.

An image recording apparatus 90 comprises a supply section 2, a recording apparatus main body 91, and a delivery section (takeup section) 4. Here, arrangement of a first recording head section 92 and a second recording head section 93 within the recording apparatus main body 91 will be explained.

As shown in FIG. 6, it is understood as viewed from the front of the recording apparatus main body 91 that the first recording head section 92 is disposed below a first drum 30 and the second recording head section 93 is disposed above a second drum 40.

Both of approaching and spacing directions 94 of the first recording head sect-on 92 relative to the first drum 30 and approaching and spacing directions 95 of the second recording head section 93 relative to the second drum 40 coincide with Y direction (height direction) of the recording apparatus main body 91 and they are parallel to each other and on the same axis regarding their positional relationship.

Regarding a position of the first recording head section 92 and a position of the second recording head section 93 at the spacing completion time, a space required by the first recording head section 92 and a space required by the second recording head section 93 overlap with each other in the same space 99 or share the same space 99. Because of this structure, the maintenance operation for the first recording head section 92 and the maintenance operation for the second recording head section 93 are performed alternately or selectively.

Regarding the approaching and spacing of the first recording head section 92 and the second recording head section 93 relative to the respective drums along the approaching and spacing directions 94 and 95, a space required by the first recording head section 94 at a spacing time and a space required for the second recording head section 93 at a spacing time share the same space 99 (overlap with each other). Therefore, maintenance operations for the first recording head section 92 and the second recording head section 93 are alternately or selectively conducted.

At a moving time of the first recording head section 92 or the second recording head section 93, tension of a recording medium in the conveying path is once released where the recording medium is moved while a portion of the recording medium between the free rollers 19 and 20 is being pressed down by the first recording head section 92 or where the recording medium is moved while a portion of the recording medium between the free rollers 19 and 20 is being pressed up by the second recording head section 93. Thereafter, when conveying behavior is conducted, paper or recording medium conveyance is performed while tension is being imparted on the recording medium.

Here, sizes of the spaces 96 and 97 required by the recording head sections at a non-recording time in the directions 94 and 95 are represented as D. Similarly, a size of the space 98 (or 99) shared by the spaces 96 and 97 in Y directions 94 and 95 is represented as E. A size of the recording apparatus main body 91 in Y direction (a direction parallel to the approaching or spacing direction) is approximately determined by a size obtained by adding (2×size D−size E) to at least diameters of two drums. A size of the recording apparatus main body 91 in the width direction is approximately determined by only the diameter of one drum.

As described above, according to the embodiment, by creating shared spaces 98 and 99 where the spaces 96 and 97 required by the respective recording head sections at the spacing completion time partially overlap with each other in Y direction (height direction), such an effect can be obtained that a height of the recording apparatus main body 91 can be reduced. Incidentally, even when the spaces required for the respective recording head sections at the spacing completion time are not caused to completely overlap with each other as a whole, if the respective recording head sections are arranged so as to obtain partial overlapping of the spaces, such an effect can be achieved that the height of the recording apparatus main body 91 can be reduced. Further, since the spaces required for the respective recording head sections to move between positions at the recording time and the positions at the spacing completion time overlap with each other on the same space 99, such an effect can be achieved that the height of the recording apparatus main body 91 can be reduced.

Incidentally, even when the spaces required for the respective recording head sections to move between positions at the recording time and positions at the spacing completion time are not caused to completely coincide with each other as a whole, if the respective recording head sections are arranged so as to obtain partial overlapping of the spaces, such an effect can be achieved that the height of the recording apparatus main body 91 is reduced. In the embodiment, both of overlap between the spaces required by the first recording head section and the second recording head section at the spacing completion time and overlap between the spaces required for the first recording head section and the second recording head section to move a position at the recording time and a position at the spacing completion time are obtained, but when either one of the overlaps is obtained, it goes without saying that the height of the recording apparatus main body 91 is reduced.

With the abovementioned configuration, an installation area for the recording apparatus main body is reduced by the reducing the width of the recording apparatus main body so that space saving can be realized. By reducing the width and the height of the recording apparatus main body, such an effect can be achieved that an apparatus which can realize size reduction and weight reduction is provided. Further, a shared space is produced by causing the spaces required to space the two recording head sections from corresponding drums to overlap with each other partially so that the conveying path length of the recording medium can be reduced and occurrence of the wasted recording medium such as a leading portion of a continuous recording medium at a loading time of the continuous recording medium can be suppressed, which results in such an effect that productivity of recording is improved.

Next, a third embodiment will be explained.

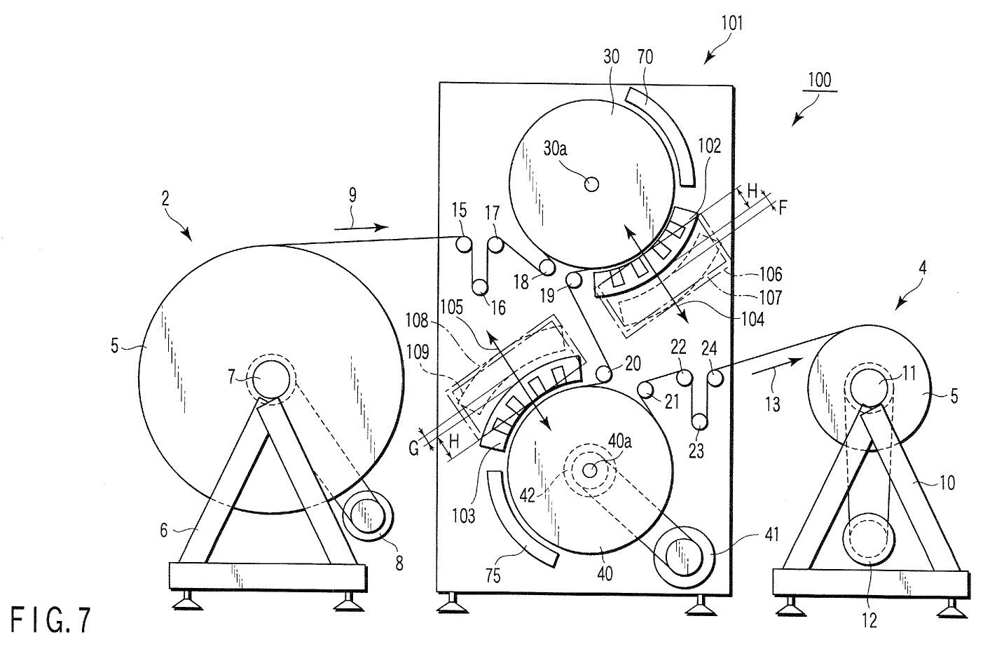

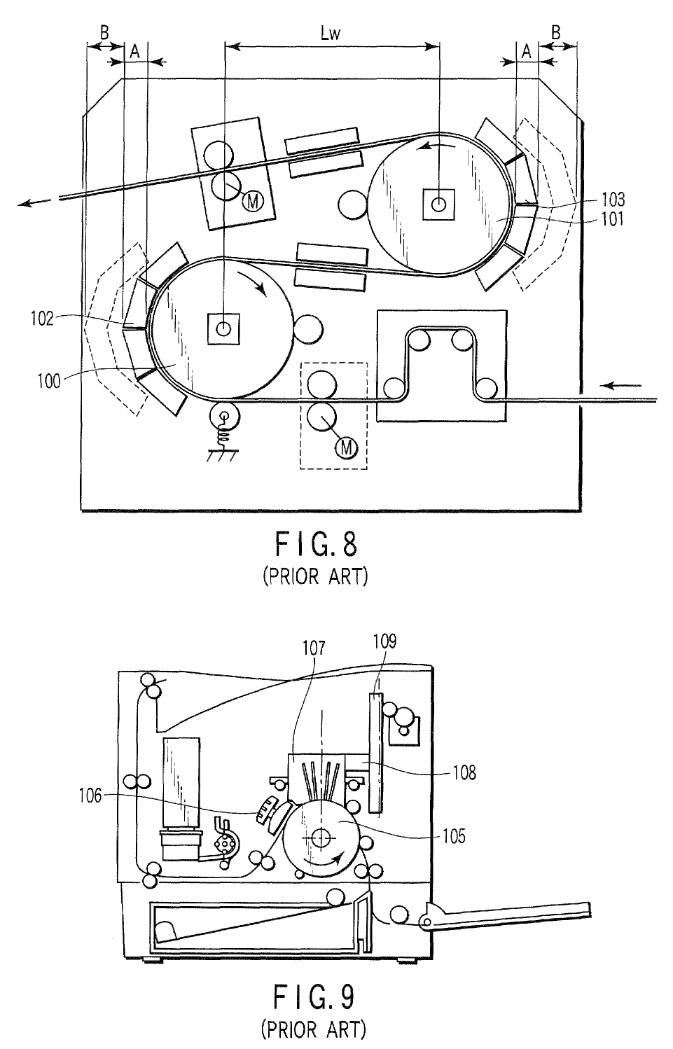

FIG. 7 is a diagram showing a configuration of an image recording apparatus according to a third embodiment of the present invention.

Configuration sections of the image recording apparatus according to the embodiment equivalent those according to the first embodiment are attached with same reference numbers and explanation thereof is omitted.

An image recording apparatus 100 comprises a supply section 2, a recording apparatus main body 101, and a delivery section (takeup section) 4. Here, an arrangement of a first recording head section 102 and a second recording head section 103 within the recording apparatus main body 101 will be explained.

As shown in FIG. 7, it is understood as viewed from the front of the recording apparatus main body 101 that the first recording head section 102 is disposed obliquely rightward below a first drum 30 and the second recording head section 103 is disposed obliquely leftward above the second drum 40.

Approaching or spacing direction 104 of the first recording head section 102 with reference to the first drum 30 and approaching or spacing direction 105 of the second recording head section 103 with reference to the second drum 40 extend along a downward-sloping axis and are parallel to each other. A space 106 required by the first recording head section 102 at the spacing completion time of the first recording head section and a space 107 required by the first recording head section at a cleaning time are assured obliquely rightward below the first recording head section 102. A space 108 required by the second recording head section 103 at the spacing completion time and a space 109 required by the second recording head section 103 at a cleaning time are assured obliquely leftward above the second recording head section 103.

With such arrangement of the first recording head section 102 and the second recording head section 103, approaching or spacing behaviors of the recording head sections relative to the drums for maintenance operation can be conducted independently from each other or conducted simultaneously. Regarding a position of the first recording head section 102 and a position of the second recording head section 103 at the spacing completion time, a space 106 required by the first recording head section 102 and a space 108 required by the second recording head section 103 in approaching or spacing directions 104, 105 overlap with each other partially.

Further, regarding the middle of approaching or spacing of the first recording head section 102 and the second recording head section 103 along the approaching or spacing directions 104 and 105, a space 107 required by the first recording head section 102 at a cleaning time and a space 109 required by the second recording head section 103 at a cleaning time partially overlap with each other in the approaching or spacing directions 104 and 105 of the respective recording head sections.

Here, when sizes of spaces required by the recording head sections at a recording time in the approaching or spacing directions 104 and 105 of the recording head sections are represented as H, a space of an overlapping portion between the space 106 required by the first recording head section 102 at the spacing completion time and the space 108 required by the second recording head section 103 at the spacing completion time in the approaching or spacing directions 104 and 105 of the respective recording head sections is represented as F, and a size of an overlapping portion between the space 107 required by the first recording head section 102 at the cleaning time and the space 109 required by the second recording head section 103 at the cleaning time in the approaching or spacing directions 104 and 105 of the respective recording head sections is represented as G, a height direction size of the recording apparatus main body 101 is approximately determined by a size obtained by adding [2×size of (size H+size G) along the height direction of the recording apparatus main body 101] to diameters of two drums. A size of the recording apparatus main body 101 in the widthwise direction is approximately determined by only a diameter of one drum.

As described above, according to the embodiment, by disposing the respective recording head sections at positions spaced from the respective drums so as to cause the spaces 106 and 108 required by the respective recording head sections at the spacing completion time to partially overlap with each other in the approaching and spacing directions 104 and 105 of the respective recording head sections, such an effect can be achieved that the height of the recording apparatus main body 101 is reduced. Incidentally, when the respective recording head sections are arranged such that the spaces 106 and 108 required by the respective recording head sections at the spacing completion time overlap with each other as a whole instead of partial overlapping between the spaces 106 and 108, such an effect can be achieved that the height of the recording apparatus main body 101 is reduced.

Further, since the spaces 107 and 109 required by the respective recording head sections at the cleaning time are caused to partially overlap with each other in the approaching or spacing directions 104 and 105 of the respective recording head sections, such an effect can be achieved that the height of the recording apparatus main body 10 can be reduced. Incidentally, when the respective recording head sections are arranged such that the spaces 107 and 109 required by the respective recording head sections at the cleaning time overlap with each other as a whole instead of partial overlapping between the spaces 107 and 109, such an effect can be achieved that the height of the recording apparatus main body 101 is reduced. In the embodiment, overlap between the spaces required by the recording head sections at the spacing completion time and overlap between the spaces required by the recording head sections at the cleaning time are obtained, but even when either one of the overlaps is obtained, it goes without saying that the height of the recording apparatus main body 101 is reduced.

With the abovementioned configuration, efficient layout of the recording head sections within the recording apparatus main body is performed, so that the width of the recording apparatus main body can be reduced and an installation area of the recording apparatus main body can be reduced, which results in such an effect as space saving.

By reducing the width and the height of the recording apparatus main body, such an effect can be achieved that size reduction and weight reduction are realized. Further, a distance between the shafts of two drums can be reduced according to increase of an overlapping region between the spaces required by the respective recording head sections at the spacing completion time and/or an overlapping region between the spaces required by the respective recording head sections at the cleaning time. Thereby, the conveying path length for the recording medium is reduced so that occurrence of wasted paper at a recording time can be suppressed, which results in such an effect that productivity of recording is improved.

According to the image recording performed according to the respective embodiments of the present invention, the following operations and effects can be obtained.
(1) At approaching or spacing times of a plurality of recording head sections relative to a plurality of drums, approaching or spacing spaces of the plurality of recording head sections overlap with one another so that a width and a height of an apparatus can be reduced. As a result, an image recording apparatus which can realize space saving, size reduction, and weight reduction of the apparatus can be provided.
(2) Spaces required by a plurality of recording head sections at approaching and spacing times of the recording head sections to drums overlap with one another, so that a width and a height of an apparatus can be reduced. As a result, an image recording apparatus which can realize space saving, size reduction, and weight reduction of the apparatus can be provided.
(3) Spaces required by a plurality of recording head sections at spacing completion time of the recording head sections to drums overlap with one another, so that a width and a height of an apparatus can be reduced. As a result, an image recording apparatus which can realize space saving, size reduction, and weight reduction of the apparatus can be provided.
(4) Approaching or spacing spaces for recording head sections overlap with one another at least partially, so that a width and a height of an apparatus can be reduced. As a result, an image recording apparatus which can realize space saving, size reduction, and weight reduction of the apparatus can be provided.
(5) A plurality of recording head sections are selectively moved such that approaching or spacing spaces for recording head sections overlap with one another at least partially, so that a width and a height of an apparatus can be reduced. As a result, an image recording apparatus which can realize space saving, size reduction, and weight reduction of the apparatus can be provided.
(6) Spaces required by recording head sections at a recording time overlap with one another in approaching and spacing directions of the recording head sections at least partially, so that a width and a height of an apparatus can be reduced in a balanced manner. As a result, an image recording apparatus which can realize space saving, size reduction, and weight reduction of the apparatus can be provided.

According to the present invention, space saving for installation occupation area is achieved by reducing size of a recording apparatus, so that an image recording apparatus which records images on both surfaces of a continuous recording medium with a simple arrangement configuration can be provided.

Incidentally, the following inventions are contained in embodiments of the present invention.

(1) An image recording apparatus comprising:

a plurality of drums which hold a continuous recording medium on outer peripheral surfaces thereof and are rotatable;

a plurality of recording head sections which can conduct recording to both surfaces of the recording medium held by the outer peripheral surfaces, are disposed so as to face the respective outer peripheral surfaces of the plurality of drums, and are movable relative to the drums; and

a recording head section moving mechanism which moves the plurality of recording head sections to drums corresponding thereto, wherein

the recording head section moving mechanism moves the plurality of recording head sections such that moving directions of the plurality of recording head sections are made parallel to a predetermined direction, and moving spaces which are moving ranges of the plurality of recording head sections in the moving directions overlap with one another in the predetermined direction at least partially.
(2) The image recording apparatus according to the above (1), wherein the moving spaces are occupation spaces of the recording head section required by the recording head sections at an approaching time to the drums or occupation spaces of the recording head section required at a spacing time.
(3) The image recording apparatus according to the above (1), wherein the moving spaces are occupation spaces of the recording head section required by the recording head sections at a spacing completion time to the drums.
(4) The image recording apparatus according to the above (3), wherein the moving spaces are occupation spaces of the recording head section required by the recording head sections at an approaching completion time to the drums.
(5) The image recording apparatus according to the above (1), wherein a spatially overlapping shared space is set in the moving spaces of the plurality of recording head sections, and

the recording head section moving mechanism moves the plurality of recording head sections so as to alternately dispose the plurality of recording head sections in the shared space.
(6) An image recording apparatus comprising:

a plurality of drums which holds a continuous recording medium on outer peripheral surfaces thereof and are rotatable;

a plurality of recording head sections which can conduct recording to both surfaces of the recording medium held by the outer peripheral surfaces, are disposed so as to face the respective outer peripheral surfaces of the plurality of drums, and are movable to the drums; and

a recording head section moving mechanism which moves the plurality of recording head sections to drums corresponding thereto, wherein

the recording head section moving mechanism moves the plurality of recording head sections such that horizontal direction components of moving spaces of the plurality of recording head sections overlap with one another in a horizontal direction at least partially.
(7) The image recording apparatus according to the above (6), wherein the moving spaces are occupation spaces of the recording head section required by the recording head sections at an approaching time to the drums or occupation spaces of the recording head section required at a spacing time of the recording head sections to the drums.
(8) The image recording apparatus according to the above (6), wherein the moving spaces are occupation spaces of the recording head section required by the recording head sections at a spacing completion time to the drums.
(9) The image recording apparatus according to the above (8), wherein the moving spaces are occupation spaces of the recording head section required by the recording head sections at an approaching completion time to the drums.
(10) The image recording apparatus according to the above (6), wherein a spatially overlapping shared space is set in the moving spaces of the plurality of recording head sections, and

the recording head section moving mechanism moves the plurality of recording head sections so as to alternately dispose the plurality of recording head sections in the shared space.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a first drum which is rotatably supported while holding a recording medium in a winding state of the recording medium on an outer peripheral surface of the first drum such that the outer peripheral surface comes in close contact with a back side of the recording medium;
a second drum which is rotatably supported while holding the recording medium in a winding state of the recording medium on an outer peripheral surface of the second drum such that the outer peripheral surface comes in close contact with an front side of the recording medium;
a first recording head which is disposed so as to face the outer peripheral surface of the first drum such that the first recording head can be spaced from the outer peripheral surface and conducts recording on the front side of the recording medium wound on the outer peripheral surface of the first drum; and
a second recording head which is disposed so as to face the outer peripheral surface of the second drum such that the second recording head can be spaced from the outer peripheral surface and conducts recording on the back side of the recording medium wound on the outer peripheral surface of the second drum,
the first recording head being movable in a first direction where the first recording head is spaced from the first drum between a recording position where the first recording head conducts recording on the recording medium on the first drum and a maintenance position where maintenance of the first recording head is performed,
the second recording head being movable in a direction parallel to the first direction between a recording position where the second recording head conducts recording on the recording medium on the second drum and a maintenance position where maintenance of the second recording head is performed, and
a movable region of the first recording head and a movable region of the second recording head being determined such that the movable regions of the first and second recording heads overlap with each other at least partially when the movable regions are projected on a plane containing a second axis parallel to the first direction and are viewed from a first axis perpendicular to the first direction.

2. The image recording apparatus according to claim 1, wherein the recording position of the first recording head and the recording position of the second recording head are determined such that the first recording head and the second recording head are projected on the plane in an at least partially overlapping manner.

3. The image recording apparatus according to claim 1, wherein the maintenance position of the first recording head and the maintenance position of the second recording head are determined such that the first recording head and the second recording head are projected on the plane in an at least partially overlapping manner.

4. The image recording apparatus according to claim 1, wherein the closest approach position of the first recording head to the first drum and the closest approach position of the second recording head to the second drum are determined such that the first recording head and the second recording head are projected on the plane in an at least partially overlapping manner.

5. The image recording apparatus according to claim 1, wherein the most spaced position of the first recording head from the first drum and the most spaced position of the second recording head from the second drum are determined such that the first recording head and the second recording head are projected on the plane in an at least partially overlapping manner.

6. The image recording apparatus according to claim 1, wherein the first drum and the second drum are arranged above and below along a gravity direction, and rotational shafts thereof are provided on the same position in a horizontal direction,
the second axis extends in a horizontal direction, and
the first recording head and the second recording head are disposed on the same side relative to the respective drums and are configured to be movable in the horizontal direction.

7. The image recording apparatus according to claim 6, wherein a direction in which the first recording head moves from the maintenance position to the recording position and a direction in which the second recording head moves from the maintenance position to the recording position are the same.

8. The image recording apparatus according to claim 1, wherein the first drum and the second drum are arranged above and below along a gravity direction, and rotational shafts thereof are provided on the same position in a horizontal direction,
the second axis extends in the gravity direction, and
the first recording head and the second recording head are disposed between the drums and are configured to be movable in the gravity direction.

9. The image recording apparatus according to claim 8, wherein a direction where the first recording head moves from the maintenance position to the recording position and a direction where the second recording head moves from the maintenance position to the recording position are opposite to each other.

10. The image recording apparatus according to claim 9, wherein a spatially overlapping shared space is provided in the movable region of the first recording head and the movable region of the second recording head, and
the first recording head and the second recording head are alternately disposed in the shared space.

11. The image recording apparatus according to claim 1, wherein the first drum and the second drum are arranged above and below along a gravity direction, and rotational shafts thereof are provided on the same position in a horizontal direction,
the second axis extends in an inclined direction, which is inclined relative to the gravity direction by a predetermined angle, and
the first recording head and the second recording head are disposed between the drums and are configured to be movable in the inclined direction.

12. The image recording apparatus according to claim 11, wherein a direction in which the first recording head moves from the maintenance position to the recording position and a direction in which the second recording head moves from the maintenance position to the recording position are opposite to each other.

13. An image recording apparatus comprising:
a first drum which is rotatably supported and holds a recording medium in a winding state on an outer peripheral surface of the first drum such that the outer peripheral surface comes in close contact with a back side of the recording medium;
a second drum which is rotatably supported and holds the recording medium in a winding state on an outer peripheral surface of the second drum such that the outer peripheral surface comes in close contact with an front side of the recording medium;
a first recording head which is disposed so as to face the outer peripheral surface of the first drum and can conduct recording on the front side of the recording medium wound on the outer peripheral surface of the first drum; and
a second recording head which is disposed so as to face the outer peripheral surface of the second drum and can conduct recording on the back side of the recording medium wound on the outer peripheral surface of the second drum, wherein
the first recording head is movable between a recording position for the recording medium wound on the first drum and a maintenance position where maintenance of the first recording head is performed, the second recording head is movable between a recording position for the recording medium wound on the second drum and a maintenance position where maintenance of the second recording head is performed, and
a movable region of the first recording head and a movable region of the second recording head are determined such that the movable regions of the first and second recording heads overlap with each other at least partially when the movable regions of the first and second recording heads are projected on a horizontal plane.

14. The image recording apparatus according to claim 13, wherein the recording position of the first recording head and the recording position of the second recording head are determined such that the first recording head and the second recording head are projected on the horizontal plane in an at least partially overlapping manner.

15. The image recording apparatus according to claim 13, wherein the maintenance position of the first recording head and the maintenance position of the second recording head determined such that the first recording head and the second recording head are projected on the horizontal plane in an at least partially overlapping manner.

16. The image recording apparatus according to claim 13, wherein the closest approach position of the first recording head to the first drum and the closest approach position of the second recording head to the second drum are determined such that the first recording head and the second recording head are projected on the horizontal plane in an at least partially overlapping manner.

17. The image recording apparatus according to claim 13, wherein the most spaced position of the first recording head from the first drum and the most spaced position of the second recording head from the second drum are determined such that the first recording head and the second recording head are projected on the horizontal plane in an at least partially overlapping manner.

18. The image recording apparatus according to claim 13, wherein the first drum and the second drum are arranged above and below along a gravity direction, and rotational shafts thereof are provided on the same position in a horizontal direction, and
the first recording head and the second recording head are disposed on the same side relative to the respective drums.

19. An image recording apparatus which records images on both surfaces of a recording medium, comprising:
a first drum which is rotatably supported and holds a recording medium in a winding state on an outer peripheral surface of the first drum such that the outer peripheral surface comes in close contact with a back side of the recording medium;
a second drum which is rotatably supported and holds the recording medium in a winding state on an outer peripheral surface of the second drum such that the outer peripheral surface comes in close contact with a front side of the recording medium;
a first recording head which is disposed so as to face the outer peripheral surface of the first drum and can conduct recording on the front side of the recording medium wound on the outer peripheral surface of the first drum; and
a second recording head which is disposed so as to face the outer peripheral surface of the second drum and can conduct recording on the back side of the recording medium wound on the outer peripheral surface of the second drum,
the first recording head being movable in a first direction between a recording position for the recording medium wound on the first drum and a maintenance position where maintenance of the first recording head is performed, the first direction being a direction in which the first recording head moves relative to the first drum,
the second recording head being movable in a second direction between a recording position for the recording medium wound on the second drum and a maintenance position where maintenance of the second recording head is performed, the second direction being a direction which is parallel to the first direction and in which the second recording head moves relative to the second drum, and
a movable region of the first recording head and a movable region of the second recording head being determined such that the movable regions of the first and second recording heads overlap with each other at least partially when the movable regions of the first and second recording heads are projected on an axis parallel to both the first and second directions.

20. An image recording apparatus comprising:
a first drum which is rotatably supported while holding a recording medium in a winding state on an outer peripheral surface of the first drum such that the outer peripheral surface comes in close contact with a back side of the recording medium;
a second drum which is rotatably supported while holding the recording medium in a winding state on an outer peripheral surface of the second drum such that the outer peripheral surface comes in close contact with an front side of the recording medium;
a first recording head which is disposed so as to face the outer peripheral surface of the first drum such that the first recording drum can be spaced from the outer peripheral surface and conducts recording on the front side of the recording medium wound on the outer peripheral surface of the first drum; and
a second recording head which is disposed so as to face the outer peripheral surface of the second drum such that the second recording drum can be spaced from the outer peripheral surface and conducts recording on the back side of the recording medium wound on the outer peripheral surface of the second drum,
the first recording head being movable in a first direction, in which the first recording head is spaced from the first drum, between a recording position where the first recording head conducts recording on the recording medium on the first drum and a maintenance position where maintenance of the first recording head is performed,
the second recording head being movable in a second direction, which is parallel to the first direction and in which the second recording head is spaced from the second drum, between a recording position where the second recording head conducts recording on the recording medium on the second drum and a maintenance position where maintenance of the second recording head is performed, and
a moving locus of the first recording head and a moving locus of the second recording head being determined such that the moving loci of the first and second recording heads overlap with each other at least partially when the moving loci are projected on an axis parallel to both the first and second directions and are viewed from an axis perpendicular to both the first and second directions.
